(19) United States
(12) Patent Application Publication
(10) Pub. No.: US 2006/0241968 A1
(43) Pub. Date: Oct. 26, 2006

(54) Ndma scalable archive hardware/software architecture for load balancing, independent processing, and querying of records

(76) Inventor: Robert J. Hollebeek, Berwyn, PA (US)

Correspondence Address: RATNERPRESTIA, P O BOX 980, VALLEY FORGE, PA, 19482-0980, US

(21) Appl. No.: 10/559,296

(22) PCT Filed: Jun. 4, 2004
(86) PCT No.: PCT/US04/17846

§ 371 Date: Apr. 20, 2006

Related U.S. Application Data
(60) Provisional application No. 60/476,214, filed on Jun. 4, 2003.

(51) Int. Cl. G06Q 10/00; G06F 12/00

(52) U.S. Cl. 705/2; 711/100

(57) ABSTRACT

A system for storing NDMA data is scalable to handle extreme amounts of data. The system allows components to be added or deleted to meet current demands. The system processes data in independent steps, providing processor level independence for every subcomponent. The system uses parallel processing and multithreading within load balancers that direct data traffic to other nodes and within all processes on the nodes themselves. The system utilizes host lists to determine where data should be directed and to determine which functions are activated on each node. Data is stored in queues which are persisted at each processing step.

### CROSS REFERENCE TO RELATED APPLICATIONS

The present application claims priority to U.S. Provisional Application No. 60/476,214, filed Jun. 4, 2003, entitled “NDMA SCALABLE ARCHIVE HARDWARE/SOFTWARE ARCHITECTURE FOR LOAD BALANCING, INDEPENDENT PROCESSING, AND QUERYING OF RECORDS,” which is hereby incorporated by reference in its entirety. The subject matter disclosed herein is related to the subject matter disclosed in U.S. patent application serial number (Attorney Docket UPN-4380/P3179), filed on even date herewith and entitled “CROSS-ENTERPRISE WALLPLUG FOR CONNECTING INTERNAL HOSPITAL/CLINIC IMAGING MEDICAL SYSTEMS TO EXTERNAL STORAGE AND RETRIEVAL SYSTEMS”, the disclosure of which is hereby incorporated by reference in its entirety. The subject matter disclosed herein is also related to the subject matter disclosed in U.S. patent application serial number (Attorney Docket UPN-4381/P3180), filed on even date herewith and entitled “NDMA SOCKET TRANSPORT PROTOCOL”, the disclosure of which is hereby incorporated by reference in its entirety. The subject matter disclosed herein is further related to the subject matter disclosed in U.S. patent application serial number (Attorney Docket UPN-4383/P3190m), filed on even date herewith and entitled “NDMA DATABASE SCHEMA, DICOM TO RELATIONAL SCHEMA TRANSLATION, AND XML TO SQL QUERY TRANSLATION”, the disclosure of which is hereby incorporated by reference in its entirety.

### FIELD OF THE INVENTION

The present invention generally relates to an architecture and method for the acquisition, storage, and distribution of large amounts of data, and, more particularly, to the acquisition, storage, and distribution of large amounts of data from DICOM compatible imaging systems and NDMA compatible storage systems.

### BACKGROUND

Prior systems for storing digital mammography data included making film copies of the digital data, storing the copies, and destroying the original data. Distribution of information basically amounted to providing copies of the copied x-rays. This approach was often chosen due to the difficulty of storing and transmitting the digital data itself. The introduction of digital medical image sources and the use of computers in processing these images after their acquisition has led to attempts to create a standard method for the transmission of medical images and their associated information. The established standard is known as the Digital Imaging and Communications in Medicine (DICOM) standard. Compliance with the DICOM standard is crucial for medical devices requiring multi-vendor support for connections with other hospital or clinic resident devices.

The DICOM standard describes protocols for permitting the transfer of medical images in a multi-vendor environment, and for facilitating the development and expansion of picture archiving and communication systems and interfacing with medical information systems. It is anticipated that many (if not all) major diagnostic medical imaging vendors will incorporate the DICOM standard into their product design. It is also anticipated that DICOM will be used by virtually every medical profession that utilizes images within the healthcare industry. Examples include cardiology, dentistry, endoscopy, mammography, ophthalmology, orthopedics, pathology, pediatrics, radiation therapy, radiology, surgery, and veterinary medical imaging applications. Thus, the utilization of the DICOM standard will facilitate communication and archiving of records from these areas in addition to mammography. Therefore, a general method for interfacing between instruments inside the hospital and external services acquired through networks and of providing services as well as information transfer is desired. It is also desired that such a method enable secure cross-enterprise access to records with proper tracking of accessed records in order to support a mobile population acquiring medical care at various times from different providers.

In order for imaging data to be available to a large number of users, an archive is appropriate. The National Digital Mammography Archive (NDMA) is an archive for storing digital mammography data. The NDMA acts as a dynamic resource for images, reports, and all other relevant information tied to the health and medical record of the patient. Also, the NDMA is a repository for current and previous year studies and provides services and applications for both clinical and research use. The development of this NDMA national breast imaging archive may very well revolutionize the breast cancer screening programs in North America. The privacy of the patients is a concern. Thus, the NDMA ensures the privacy and confidentiality of the patients, and is compliant with all relevant federal regulations.

To facilitate distribution of this imaging data, DICOM compatible systems should be coupled to the NDMA. To reach a large number of users, the Internet would seem appropriate; however, the Internet is not designed to handle the protocols utilized in DICOM. Therefore, while NDMA supports DICOM formats for records and supports certain DICGOM interactions within the hospital, NDMA uses its own protocols and procedures for file transfer and manipulation. The resulting collections of data can be extremely large.

Previous attempts to handle large amounts of data are described in U.S. Pat. NO. 5,937,428, issued to Jantz (Jantz) and U.S. Pat. No. 6,418,475, issued to Fuchs (Fuchs). Jantz discloses a RAID (redundant array of inexpensive disks) storage system for balancing the Input/Output workload between multiple redundant array controllers. Jantz attempts to balance the processing load by monitoring the number of requests on each processing queu e and delivering new read requests to a controller having the shorter queue. Fuchs discloses a medical imaging system having a number of memory systems and a control system that controls storage of image data in the memory systems. Successive images datasets are stored in separate memory systems, and the system distributes loads into different memory systems in an attempt to avoid peak loads. However, neither Jantz nor Fuchs addresses the NDMA or the specific issues associated with handling large amounts of NDMA compatible data.

Thus, a need exists for an architecture that couples DICOM compatible systems to the NDMA and provides high capacity and scalability for acquisition, storage and redistribution that can serve a large number of distinct but administratively separate enterprises with large-scale processing, storage and retrieval characteristics suitable for use with the NDMA standards and protocols.

### SUMMARY OF THE INVENTION

A system for storing NDMA compatible data, such as image data, is scalable to handle extreme amounts of data. This is achieved in the NDMA architecture by using a combination of load balancing front-ends coupled to collections of processing and database nodes coupled to storage managers and by preserving independence for processing and retrieval at the individual record level. The system allows components to be added or deleted to meet current demands and processes data in independent steps, providing processor level independence for every subcomponent. The system uses parallel processing and multithreading within load balancers that direct data traffic to other nodes and within all processes on the nodes themselves. Host lists are utilized to determine where data should be directed and to determine which functions are activated on each node. Data is stored in queues which are persisted at each processing step.

The scalable system for storing NDMA related data in accordance with the invention includes a front end receiver section, a front end balancer section, at least one back end receiver section, and at least one back end handler section. The front end receiver section includes several host processors (hosts). The hosts receive the NDMA related data and format the NDMA related data into data queues. The front end balancer section also includes several hosts. These hosts receive the data queues from the front end receiver section, balance the processing load of the data queues, and transmit the data queues to a plurality of hosts specified by at least one host list. The back end receiver section (or sections) receive the data queues from the front end balancer section(s) and provide the data queues to selected portions of a multiplicity of back end handlers in accordance with the host list(s). The back end handler section (or sections) store, perform queries, and audit the NDMA related data.

### BRIEF DESCRIPTION OF THE DRAWINGS

FIG. 1 is an illustration of storage hierarchy layers arrangeable geographically to match available network communications trunk bandwidth characteristics in accordance with an exemplary embodiment of the present invention;

FIG. 2 is a block diagram of a WallPlug implementation of storage and retrieval for level 1 in the storage hierarchy in accordance with an exemplary embodiment of the present invention;

FIG. 3 is a block diagram of software components in the load balancer and backend section of the NDMA utilized to transfer data to and from the NDMA in accordance with an exemplary embodiment of the present invention;

FIG. 4 is a block diagram of a single machine implementation of the scalable system in accordance with an exemplary embodiment of the present invention;

FIG. 5 is a block diagram of a multiple machine implementation of the scalable system in accordance with an exemplary embodiment of the present invention;

FIG. 6 is a block diagram of the scalable system showing a network I/O layer, a load balance an input layer, a core database layer, and a processing an application layer in accordance with an exemplary embodiment of the present invention;

FIG. 7 is a block diagram of software components utilized to store data in an NDMA Archive System in accordance with an exemplary embodiment of the present invention;

FIG. 8 is a block diagram of software components utilized to audit data and track use and movement of records in an NDMA Archive System in accordance with an exemplary embodiment of the present invention;

FIG. 9 is a block diagram of software components utilized to perform a query and to retrieve records in an NDMA Archive System in accordance with an exemplary embodiment of the present invention;

FIG. 10 is a diagram the NDMA system illustrating the flow of data in a multiple storage and query configuration in accordance with an exemplary embodiment of the present invention;

FIG. 11 illustrates the scalable characteristics of the system and the capacity goals for the storage hierarchy in accordance with an exemplary embodiment of the present invention; and

FIG. 12 illustrates an exemplary connection between two hospital devices connected to an area archive with network replication on a regional archive in accordance with an exemplary embodiment of the present invention.

### DESCRIPTION OF EMBODIMENTS OF THE INVENTION

An NDMA scalable archive system for load balancing, independent processing, and querying of records in accordance with the present invention comprises a front end receiver section, a front end balancer section, at least one back end receiver section, and at least one back end handler section. The system partitions processing into a number of independent steps. The system provides processor level independence for every subcomponent of the processing requirements. For example, nodes can process records independently of each other. The system utilizes parallel processing and multithreading (i.e. can process multiple records simultaneously) both within load balancers that direct traffic to other nodes and within all processes on the nodes themselves. Processing is determined from lists of available processor nodes. The list of processor nodes can be modified (expanded or reduced) to meet capacity requirements. Subsets of the storage collection (stored data) are independently managed by individual nodes. Data is moved between processing steps through persistent queues (i.e., data is stored on disk before the storage completion is acknowledged). Socket communications are utilized between processes so that processes can operate simultaneously on one node or can be transparently spread across multiple nodes. This applies to nodes that are geographically dispersed or to nodes that are heterogeneous in hardware or operating system.

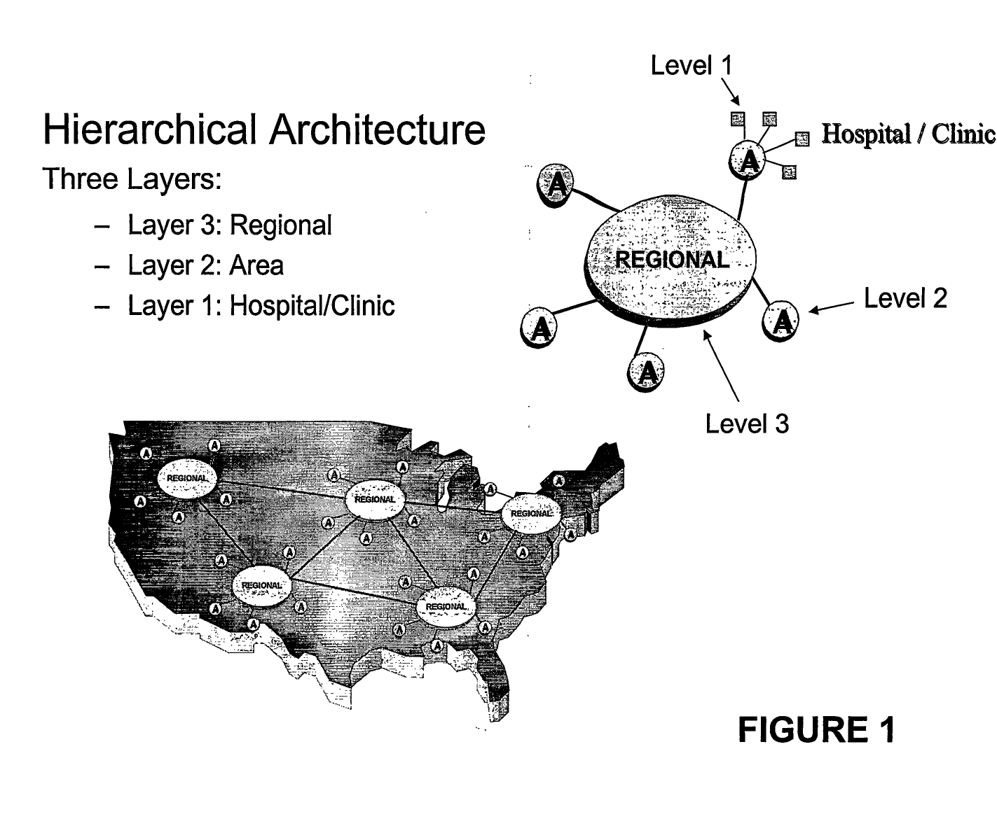

Referring now to FIG. 1, in which is shown an illustration of storage hierarchy layers that can be arranged geographically to match available network communications trunk bandwidth characteristics in accordance with an exemplary embodiment of the present invention, the illustrated NDMA, uses a three level hierarchy for storage. Because the eventual volume of NDMA data from mammography is so high (potentially 28 Terabytes per day if all hospitals convert to digital storage), a three level hierarchy and a scalable architecture for the Level 2 and 3 sites is utilized. The storage hierarchy comprises three layers (or levels): layer 1 with small connectors at hospital/clinic locations, layer 2 with area archives that manage portions of the collections, and layer three regional systems that manage area collections and use network replication to provide disaster recovery. Level 1 is a minimal footprint at the data collection site (hospital or hospital enterprise). Level 2 is capable of serving the needs of 50-100 hospitals and has storage for caching requests, frequently used records, and records about to be used due to patient scheduled visits. Level 3 has bulk storage for all connected sites together with network replication.

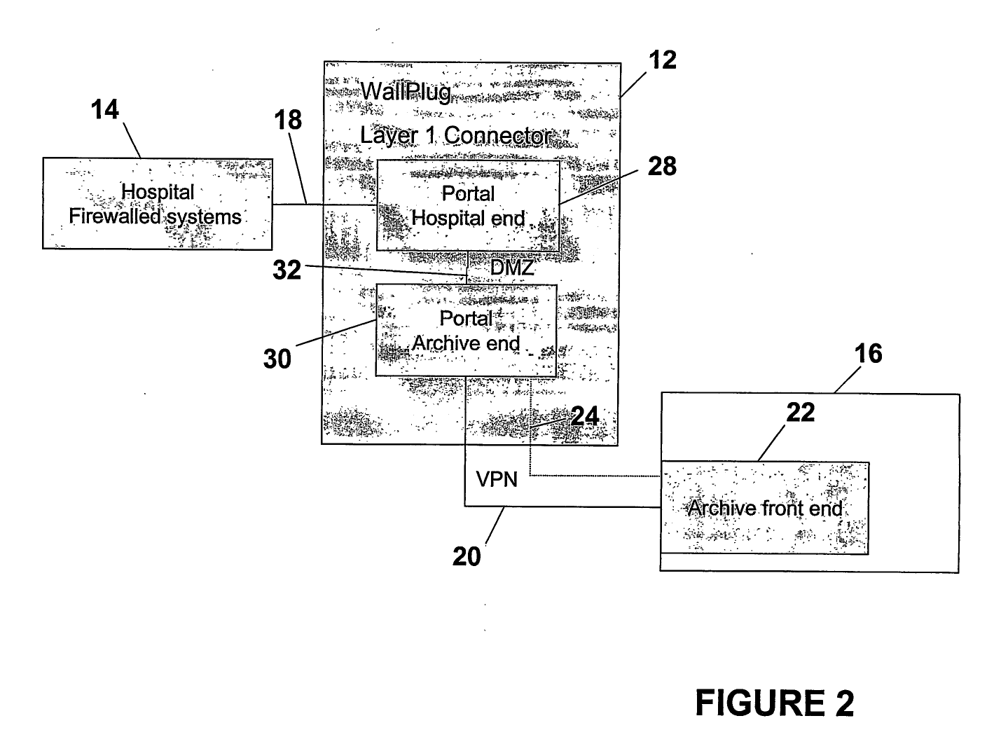

FIG. 2 is a block diagram of a WallPlug 12 implementation of storage and retrieval for level 1 in the storage hierarchy in accordance with an exemplary embodiment of the present invention. It consists of a first portal 28 coupled to the internal hospital/clinic 14 via TCPIP compatible network 18, a second portal 30 coupled to the archive 16 via virtual private network 20, 24, and the two portals coupled together via a private secure network 32. As shown in FIG. 2, the WallPlug 12 is the layer 1 connector for devices and has two external network connections. One) is connected to the hospital network 18, and the second is connected to an encrypted external Virtual Private Network (VPN) 20. The WallPlug 12 presents a secure web user interface and a DICOM hospital instrument interface on the hospital side and a secure connection to the archive front end 22 of the archive 16 on the VPN side. The system makes no assumptions about external connectivity of the connected hospital systems. The WallPlug 12 has a second external connection (to redundant network 24) to provide communications redundancy and hardware testing and management in the event of a failure. The external VPN also provides Grid services and application access. Grid is an open standards implementation of mechanisms for providing authentication, and access to services via networks. Open standards are publicly available specifications for enhancing compatibiity between various hardware and software components.

As shown in FIG. 2, the hardware design of the WallPlug 12 comprises two portals 28, 30 that are linked together with a private secure network 32 comprising a single crossover cable on which all protocols and transmissions can be controlled and to which no access is provided (other than via those protocols) from the outside. Each portal 28, 30 has at least two network devices. In an exemplary configuration, two interfaces, one from each portal 28, 30, are connected together with a short crossover cable and the address space on that network is a non-routed 10.0.0.0/8 private network. This network is a private address space as defined in RFC 1918 (TCPIP standard). Additionally, the address space of this isolated network is defined on a separate network interface which is not routed to any other networks or interfaces (referred to as a non-routed network). This network forms the private link 32 between the portals 28, 30. For a better understanding of the WallPlug 12, please refer to the related application entitled, “CROSS-ENTERPRISE WALLPLUG FOR CONNECTING INTERNAL HOSPITAL/CLINIC MEDICAL IMAGING SYSTEMS TO EXTERNAL STORAGE AND RETRIEVAL SYSTEMS”, Attorney Docket UPN-4380/P3179, filed on even date herewith, the disclosure of which is hereby incorporated by reference in its entirety.

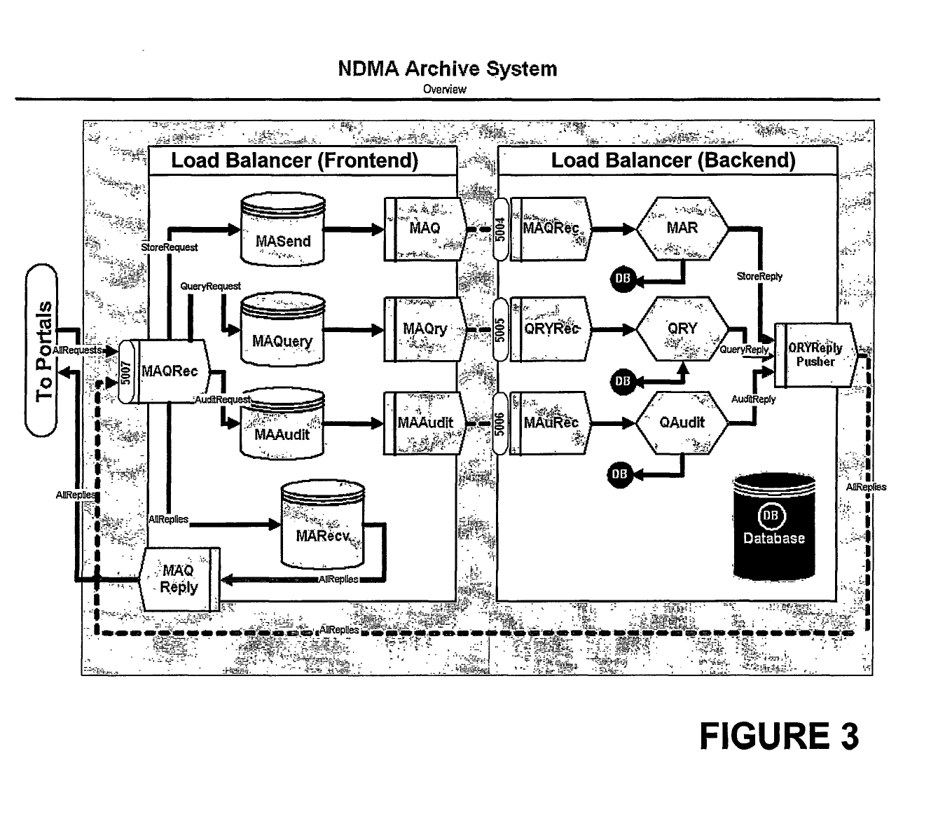

FIG. 3 is a block diagram of software components in the load balancer and backend section of the NDMA utilized to transfer data to and from the NDMA in accordance with an exemplary embodiment of the present invention. This architecture is used in both layers 2 and 3 of the storage hierarchy. Thus, FIG. 3 depicts an overview of the archive system which can be used to construct both layer 2 and layer 3 resources.

Processing Steps

The data flow through the load balancer and backend section software illustrated in FIG. 3 includes front end input handlers, followed by front end load balancers, followed by backend load balancers as illustrated in FIG. 3. Each process uses a receiver and a queue handler. The following is an outline of the processes utilized in the NDMA Archive in accordance with an exemplary embodiment of the present invention:
Frontend I/O receivers:
   MAQRec is a multithreaded primary frontend receiver fom the wide area network (WAN) running on port 5007. MAQRec has an output queue /MASend with replication in /MASend/bak (not shown).
Frontend balancers and queue movers:
   MAQ is a frontend balancer for storage that sends files to nodes listed in hostlistMAQ stored in input queue MASend.
   MAQry is a load balancer for query processing for queries stored in input queue MAQuery.
   MAQReply is a query reply handler that handles replies stored in queue MARecv.
   MAAudit is a HIPPA Audit storage handler that processes audit requests stored in input queue MAAudit.
   QRYReplyPusher is a query reply handler that provides replies to outbound MAQRec. [WHERE?]
   MAForward: request re-director for processing queries
Backend Receivers
   Storage: MAQRec is a storage device connected to port 5004; queue /mar/MARs.
   Query: qryRec is a storage device connected to port 5005; queue /qry/QRYq.
   Audit: MaARec is a storage device connected to port 5006; queue /mar/QAudits.
Backend handlers
   MAR handles storage requests;
   QRY handles Queries; and
   QAudit handles Query audits.

With reference to the above outline and FIG. 3, the Frontend I/O receiver section comprises the MAQRec and MASend processes. The MAQRec process is the multithreaded primary frontend receiver from the wide area network. The MKQRec process provides data to the output queue MASend with replication in MASend/bak (not shown in FIG. 3).

The Frontend balancers and queue movers comprise the following processes: MAQ, MAQry, MAQReply, MAAudit, QRYReplyPusher, MAQBak (not shown in FIG. 3), and MA Forward (not shown in FIG. 3). The MAQ process is the frontend balancer for storage. It sends files to nodes listed in hostlistMAQ. The MAQry process is the balancer for query processing. The MAQReply process is a query reply handler. The MAAudit process is the HIPP A Audit storage handler. The QRYReplyPusher process is a reply handler to the outbound MAQRec process. The MAQBak process is a sender for network replication. The MAForward process request re-director for processing queries.

The backend receiver section utilizes the MAQRec process with queues MAR and /inar/MARs, sending data for storage of data using the process MAR; the MAQRec process with queues /qry and /QRYq for performing query functions through the process QRY; and the MAQRec process with queues /mar and /QAudits for performing audit functions. The intervening queues within /mar and /qry are not shown in the Backend illustration of FIG. 3. They play the same role as the corresponding queues MASend, MAQuery, MAAudit in the frontend nodes.

The backend handler section utilizes the MAR process for performing storage functions, the QRY process for performing query functions, and the QAudit process for performing query audits.

All of the processes fall into one of three classes: senders, receivers, and processors. Senders and receivers use a socket protocol to communicate so that items can be processed either locally or on a remote node, or both regardless of whether the nodes are on internal or external networks. For a better understanding of this protocol, please refer to the related application entitled, “NDMA SOCKET TRANSPORT PROTOCOL”, Attorney Docket UPN-4381/P3180, filed on even date herewith, the disclosure of which is hereby incorporated by reference in its entirety. Processors work solely off input and output persistent queues thus guaranteeing that the systems will restart automatically after system outages.

Single Machine Example

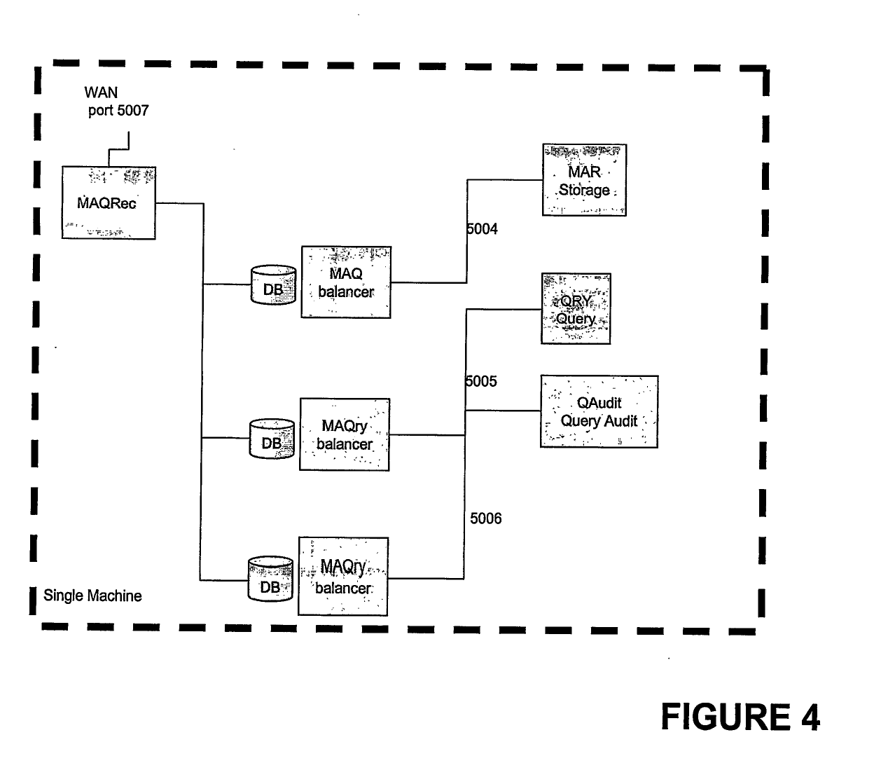

FIG. 4 is a block diagram of a single machine implementation of the scalable system, wherein the scalable architecture is used with all processes, queues and handlers instantiated on a single machine node in accordance with an exemplary embodiment of the present invention. To implement all processes on a single machine, all controlling host lists contain a pointer to the local machine. The process flow then looks as illustrated in FIG. 4.

Multiple Node Layout

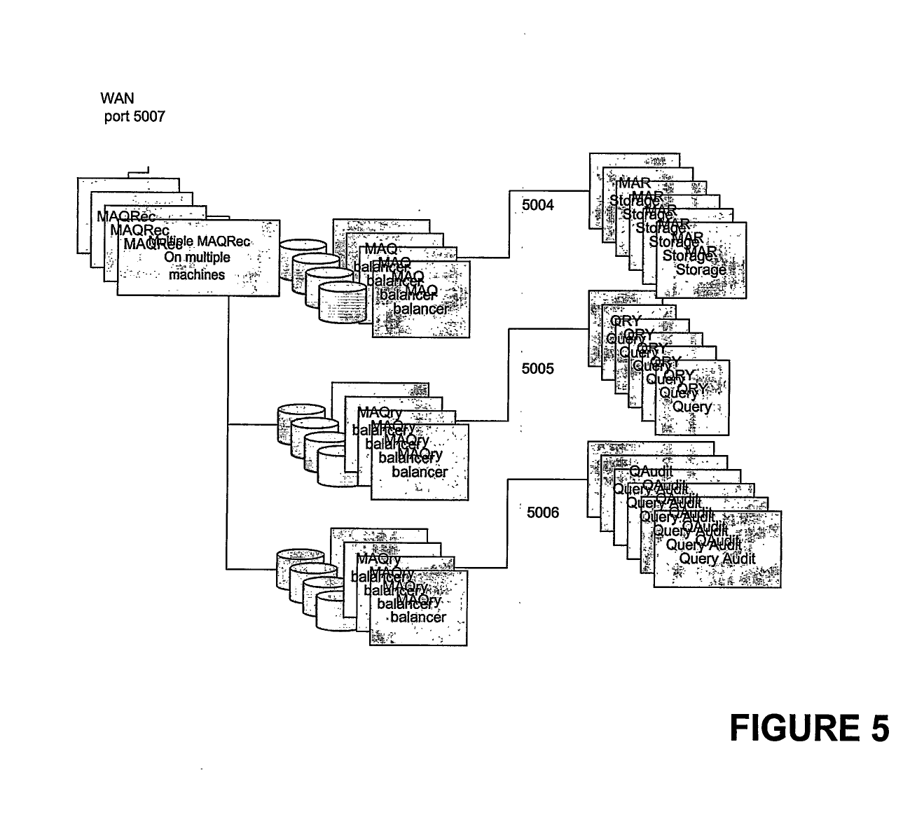

FIG. 5 illustrates a multiple node layout wherein multiple machine implementation of the scalable system multiple balancers, queue handlers and data handlers are instantiated on multiple machines in accordance with an exemplary embodiment of the present invention. Since the assignment of any machine is controlled by hostlists, and since the communication is through sockets, it is possible to have multiple input machines, each of which sends to multiple queue balancers, each of which manages a pool of machines. Individual machines can simultaneously operate as input processors, queue balancers or backend processors or they can specialize as one or more of these functions. This provides the ability to define a topology in which extra nodes can be added to any of the basic functions as needed. These nodes can in turn be nodes that are local, remote, geographically distributed or heterogeneous.

Scalable High Capacity System

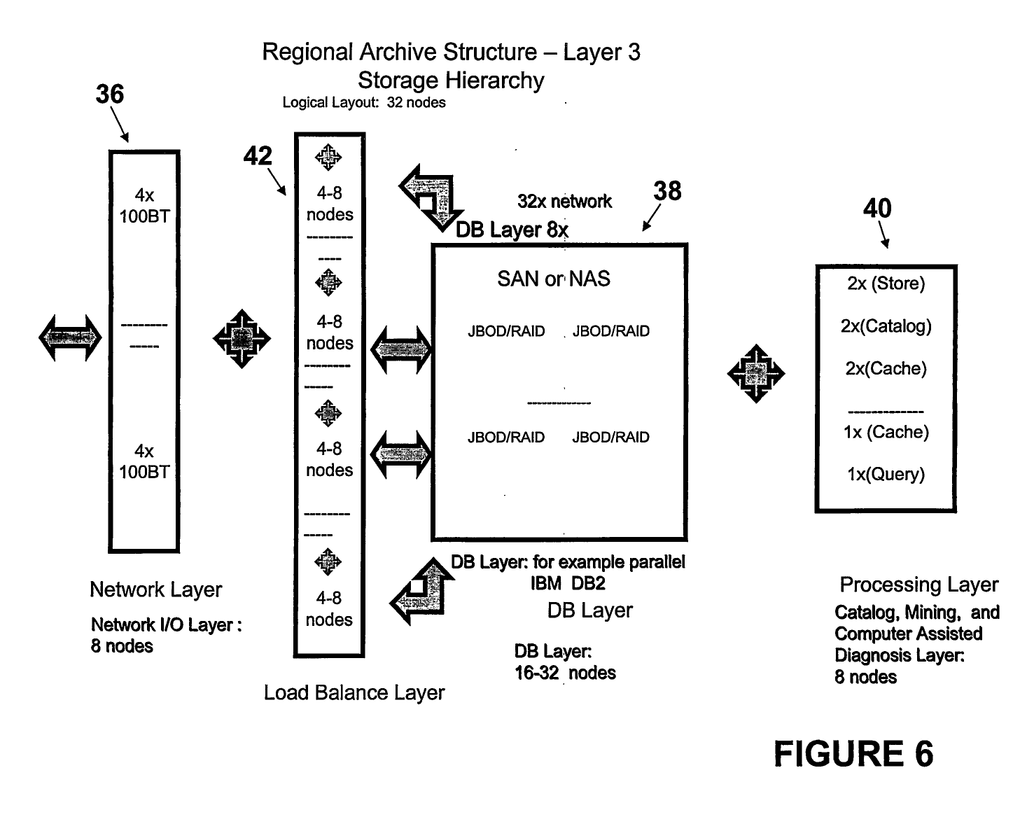

FIG. 6 is a block diagram of the scalable system showing an input network layer 36, a database (DB) layer 38, and a processing layer 40, and a load balance layer 42 wherein all functions can be assigned to distributed and/or clustered machines in accordance with an exemplary embodiment of the present invention. It is envisioned that the NDMA Archive will be a petabyte capable system for storage in regional layer 3 of the storage hierarchy. Accordingly, in one embodiment, the system comprises the following architecture: An input network layer 36, a DB layer 38, and a processing layer 40. Storage within the DB layer can be implemented in any appropriate storage mechanism; for example connections to a storage area network (SAN) or network attached storage or arrays of disk implemented with redundant arrays of independent disk (RAID) or “just a bunch of disks” (JBOD). Communications between the layers use queues and send/receive pairs as described above so the layout can be flexible. The input network layer 36 runs with multiple nodes running MAQRec and connected to the outside WAN. A database layer 38 with multiple nodes interconnected by switch or other network hardware and NDMA sockets runs a parallel IBM database (DB2) or equivalent. This makes the load balance layer 42 and the DB layer 38 a virtual single machine for file services and DB functions. The front end of this virtual single machine is a multi-node balancer 42, in which each of the nodes can individually manage a large backend storage area network or collections of network attached storage.

Maintaining Machine Independence

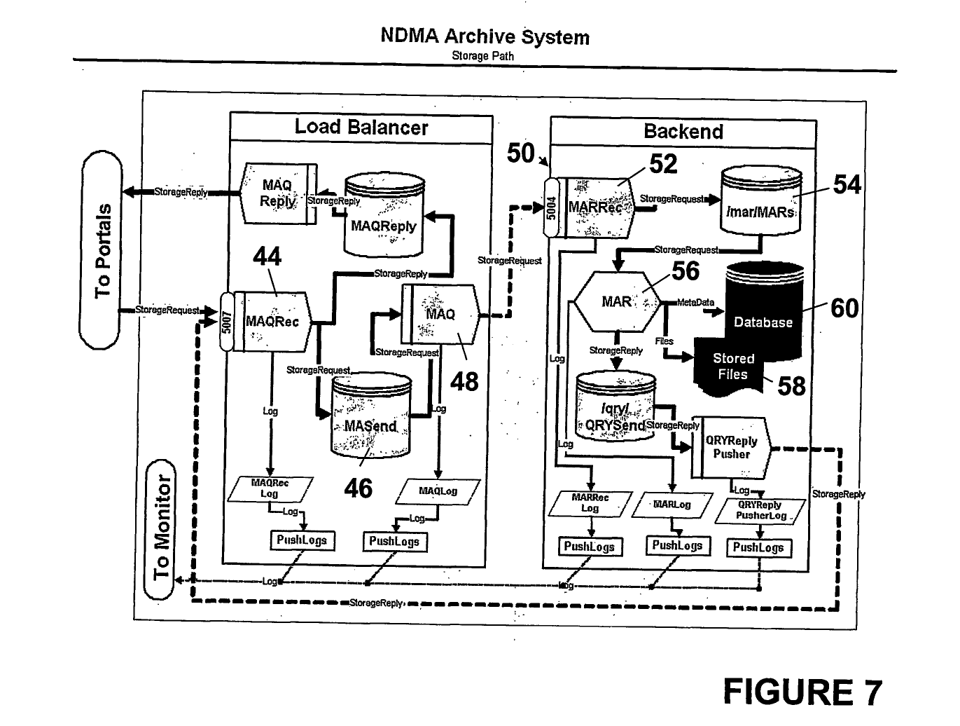

FIG. 7 is a block diagram of software components utilized to store data in the NDMA Archive System in accordance with an exemplary embodiment of the present invention. As depicted in FIG. 7, the NDMA archive stores medical records as individual files. For the scalable approach to work, it is preferred that nodes can each independently process requests with minimal interaction with other nodes, and no interaction with other requests. This is accomplished with storage requests in the following way. A balancer node running MAQRec 44 removes storage requests from its incoming queue 46 and can independently send them using the sender MAQ 48 to storage nodes 50. Each storage node receives files 52, removes them from a queue 54, processes files 56, and stores its file 58 independently. It updates a common database 60 and can also send copies of the database entries to another location (DB) using the QRYReplyPusher as indicated. In a distributed embodiment, the database information is extracted into an XML NDMA structure and forwarded to a DB node for database update A second copy of the XML can be sent to a backup database or replica database for cataloging. In this arrangement, all records can be stored without interaction between storage nodes. This scalable approach using record level processing independence guarantees that the capacity of the system is scalable.

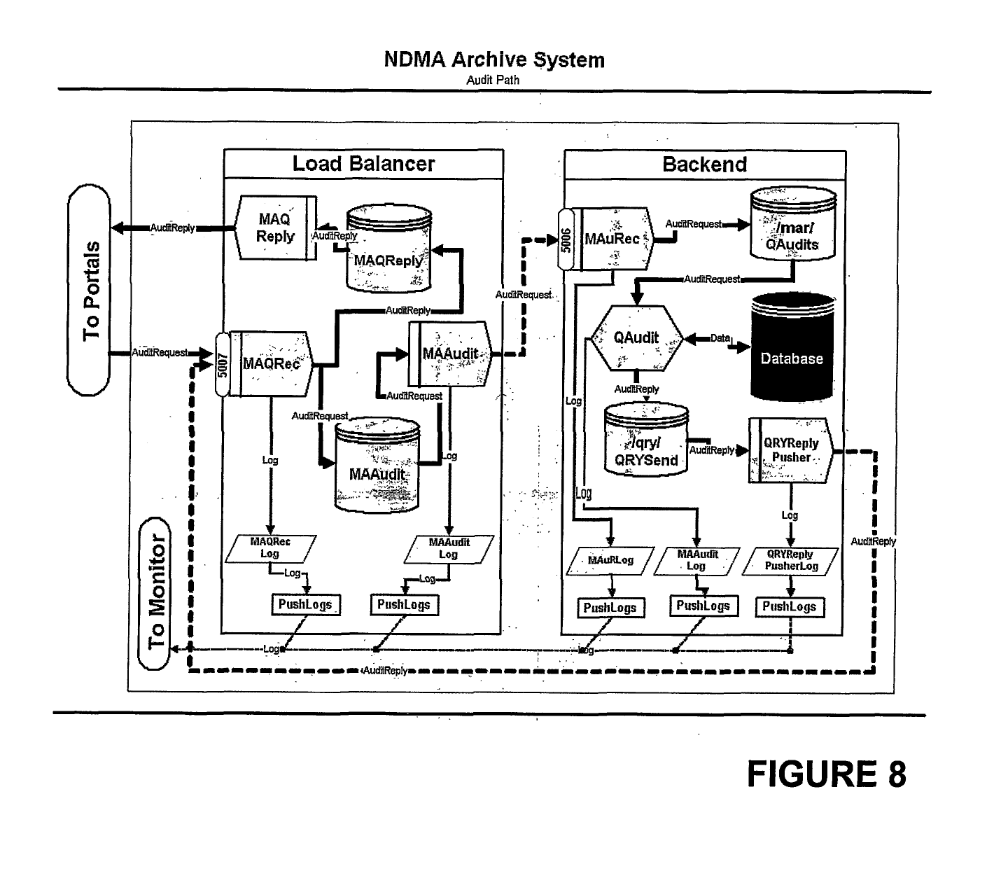

FIG. 8 is a block diagram of software components utilized to audit data and track use and movement of records in the NDMA Archive System in accordance with an exemplary embodiment of the present invention. The audit processing path depicted in FIG. 8 is substantially similar to the storage processing path described above except that audit data is stored in the database instead of actual files.

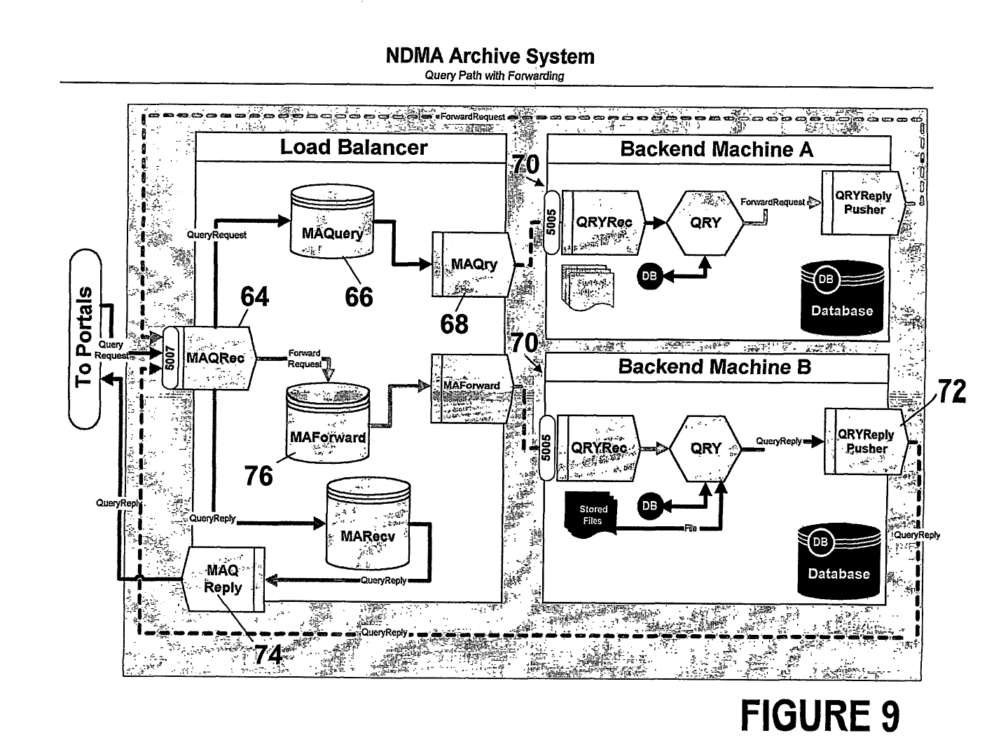

FIG. 9 is a block diagram of software components utilized to perform a query and to retrieve records in accordance with an exemplary embodiment of the present invention. Independent query processing is more complex to arrange and still preserve record level processing independence. By adjusting the query processing to retain this independence, scalable performance is preserved. Incoming queries are sent by a balancer 64 (of which there may be multiple instances) through a queue 66 and a sender 68 to query processing nodes 70 of which there may be many instances. The query processing node sends a query to the database to determine the location of files required to respond to the query. The node prepares the XML headers for all responses as required by the NDMA protocols and sockets and then divides the replies into those for which it has direct access to the required records and those for which the records are resident on some other node or at some other location. For the former, the node attaches the response record to the header and sends 72 the completed record to the query response node 74. For the latter, the header is forwarded through the balancer 64 to the specific node with the required content. This is accomplished by sending it through the MAForward process 76. Nodes responding to Forward requests do not have to query the database. They only need to attach the requested record to the header XML which they received in the Forward queue. This somewhat more complex arrangement removes inter-node dependence even for queries that require responses from multiple nodes. All communication is between the balancer nodes 64 and the sub-nodes 70. The latter also makes it easier to layout hardware architectures since it does not require high-speed communication from a node to all other nodes, but only to the balancer node.

### EXAMPLE

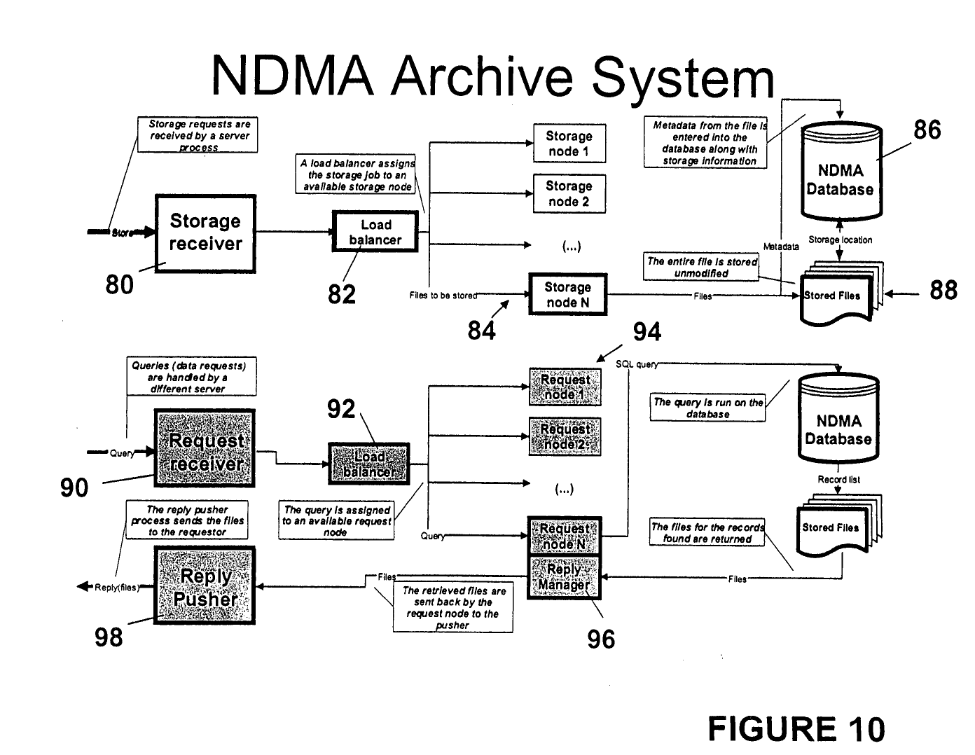

FIG. 10 illustrates the flow of data in a multiple storage and query configuration (For simplicity, the Forward function is not illustrated in FIG. 10).

Incoming storage requests are handled by an MAQRec receiver layer 80 of which there may be one or several instances distributed across one or more machines. MAQ senders 82 of which there can be many, push incoming storage requests to Storage nodes 84 using any appropriate load balancing technique. Storage nodes store files in their managed file spaces 88 and indices in the database 86. At the conclusion of a successful store, a reply message is generated and placed in the reply queue (not shown). This reply is automatically routed by the Reply Pusher 98 discussed below.

Incoming query requests are handled by an MAQRec receiver layer 90 of which there may be one or several instances distributed across one or more machines the same as or different from the machines handling the storage requests. MAQ senders 92 of which there can be many, push incoming query requests to request nodes 94 using any appropriate load balancing technique. Request nodes query the indices 86 and locate all files necessary to satisfy the request. In the case of files managed locally, the files are fetched and formatted according to NDMA protocols by the Reply Manager 96. Completed replies are sent to the Reply Pusher 98 which routes them back to the requesting location. For files which are not local, the Reply Manager 96 sends the protocol elements back to the load balancer 92 which directs the request to the reply manager on the node which controls the data. This node then completes the process by fetching the requested file, attaching the protocol elements, and sending the file to the reply pusher. The latter more complicated procedure is used to maintain record level independence and to avoid direct network traffic crossing between Request nodes.

An embodiment of the NDMA Archive has been implemented in several “Area” archives and two “Regional” archives to demonstrate the flexibility of this arrangement. Numbers of processors vary from one to as many as 32, and nodes are located in geographically distributed locations. The design allows expansion of the capacity of the system almost without limit, and also can be tuned to that the capacity need only be expanded in those functions where additional capacity is needed.

Three Level Storage Hierarchy

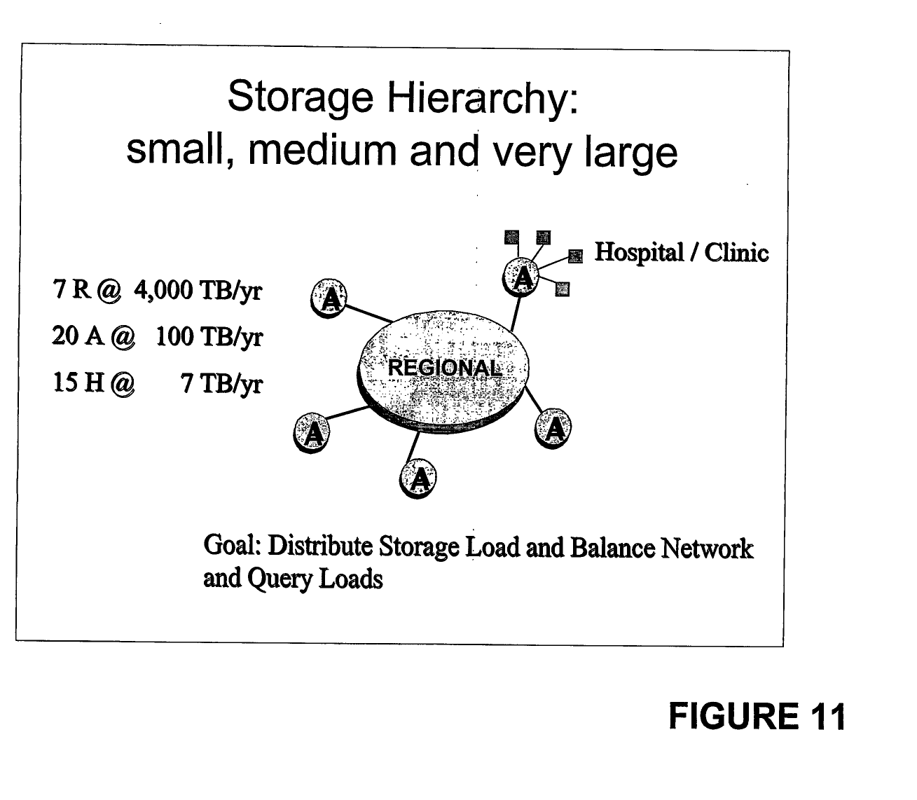

FIG. 11 illustrates the scalable characteristics of the system and the capacity goals for the storage hierarchy in accordance with an exemplary embodiment of the present invention. The NDMA-uses a three level hierarchy for storage of medical records, as illustrated in FIGS. 1 and 11. In the same way that the internal operations of the NDMA Archive System are facilitated by the scalable approach using send/receive pairs, the larger components, i.e. area and regional archives can also be viewed on a larger scale as processor nodes and balancers. The NDMA send/receive socket layers can be implemented as WAN connections between area and regional storage nodes. Network replication of records in the hierarchy is accomplished by using the MAQBak process with a hostlist that points to another archive. Intercommunication between area and regional (i.e. geographically separated locations) is a larger example of the same principle used to implement NDMA services either on one single node or on multiple nodes.

Example Implementation of Area to Regional Communication

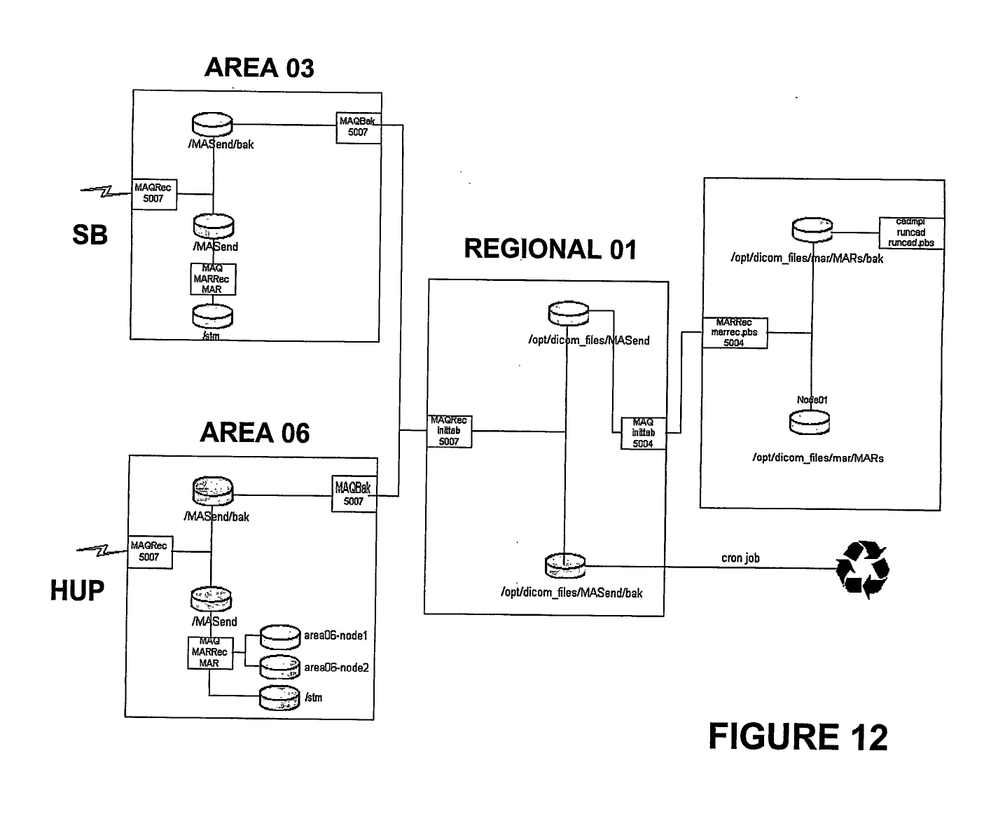

FIG. 12 shows an exemplary implementation of a connection between two hospital enterprises, SB (e.g., Sunnybrook and Womens College Health System) in Toronto and HUP (Hospital University of Pennsylvania in Philadelphia), connected to two area archives, AREA 03 and AREA 06, respectively, which are in turn connected to a the regional machine, Regional 01. In this case, the regional machine, Regional 01, is receiving replicated traffic from the area archives through the MAQBak process. The regional machine balancer in this example is shown running one of the backend processes only (MAQRec).MAR ec). This example illustrates the flexible way in which even geographically or administratively separate machines can be linked together into a processing structure.

An NDMA scalable archive system for load balancing, independent processing, and querying of records in accordance with the present invention is capable of handling extremely large amounts of data. To accomplish this, the NDMA architecture uses a three level hierarchy; hospital systems (level 1), multiple hospital enterprise collectors (level 2), and collectors of collectors (level 3). All processing requirements for storage, query, audit, or indexing are broken down into independent steps to be executed on independent nodes. All nodes process requests independently and all processes are multithreaded. Multiple instances of processes can be executed. Processor functions are controlled by lists of hosts. Each function has such a list and processors can perform more than one function. Processes work solely from persistent queues of records and requests to be processed. Processors can be geographically distributed, locally resident on a single computer, or resident on multiple computers. The archive systems use a group of processors for input and output to the core and for load balancing input and output requirements. The archive systems use a core collection of nodes for processing, with the functions of each node controlled by the process hostlists in which it occurs. For queries in which independent nodes still process requests, requested data can be spread across many nodes. Nodes can use “forward” requests through a balancer to instruct another processor to complete the sending of a record. This maintains scalable node independence even when a node does not have direct access to a requested file. The archive systems described herein can also have a collection of processors dedicated to image processing and Computer Assisted Detection (CAD) algorithms. Thus CAD algorithms can be centrally provided to multiple enterprises through this mechanism.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed:

1. A scalable system for storing National Digital Mammography Archive (NDMA) related data, said system comprising:
a front end receiver section comprising a plurality of host processors that receive said NDMA related data and format said NDMA related data into data queues;
a front end balancer section comprising a plurality of host processors that receive said data queues from said front end receiver section, balance a processing load of said data queues, and transmit said data queues to respective ones of said plurality of host processors in accordance with a host list;
a back end receiver section that receives said data queues from said front end balancer section and provides said data queues to selected portions of a plurality of back end handlers in accordance with said host list; and
said plurality of back end handlers storing said NDMA related data, performing queries on said NDMA related data, and auditing said NDMA related data.

2. A system in accordance with claim 1, wherein said front end receiver section comprises a plurality of front end receivers.

3. A system in accordance with claim 1, wherein said front end balancer section comprises a plurality of front end balancers.

4. A system in accordance with claim 1, wherein said back end receiver section comprises a plurality of back end receivers.

5. A system in accordance with claim 1, wherein said back end handler comprises at least one storage mechanism, at least one query processor, and at least one audit processor.

6. A system in accordance with claim 1, wherein said NDMA related data is formatted into records and individual records are processed independently.

7. A system in accordance with claim 1, wherein a plurality of said data queues are concurrently processed.

8. A system in accordance with claim 1, wherein:
said front end receiver section forms an input layer;
said front end balancer section directs a core database layer;
said back end handler section forms an application layer; and
said NDMA related data is transferred among said layers via data queues and send/receive pairs.

9. A system in accordance with claim 1, wherein at least two of said front end receiver section, said front end balancer section, said back end receiver section, and said back end handlers are geographically dispersed.

10. A system in accordance with claim 1, wherein:
each request to store NDMA data is processed independent of other requests to store NDMA related data; and
each request to query NDMA data is processed independent of other requests to query NDMA related data.

11. A system in accordance with claim 1, wherein extensible markup language (XML) headers are created for all responses to a query in accordance with NDMA protocols and sockets, and said responses are bifurcated into responses for which applicable response records are directly accessible and for which applicable response records are not directly accessible.
